(19) United States
(12) Patent Application Publication
(10) Pub. No.: US 2026/0343234 A1
(43) Pub. Date: Oct. 29, 2026

(54) TIME SYNCHRONIZATION BETWEEN TSN ENTITIES OF TSN SYSTEM

(71) Applicant: Telefonaktiebolaget LM Ericsson (publ), Stockholm (SE)

(72) Inventors: Dhruvin PATEL, AACHEN (DE); Joachim SACHS, SOLLENTUNA (SE); János FARKAS, KECSKEMÉT (HU); János HARMATOS, Budapest (HU); Balázs VARGA, BUDAPEST (HU); Marilet De Andrade JARDIM, KISTA (SE); György MIKLÓS, PILISBOROSJENÖ (HU)

(73) Assignee: Telefonaktiebolaget LM Ericsson (publ), Stockholm (SE)

(21) Appl. No.: 19/123,063

(22) PCT Filed: Nov. 7, 2022
(86) PCT No.: PCT/SE2022/051022

§ 371 Date: Apr. 22, 2025

(51) Int. Cl. H04W 12/12; H04J 3/06; H04W 12/61

(52) U.S. Cl. CPC H04W 12/12; H04J 3/0667; H04W 12/61

(57) ABSTRACT

Embodiments of the present disclosure provide a method (500) for providing time synchronization between Time-Sensitive Networking, TSN, entities of a TSN system (100). The TSN system (100) is integrated to a wireless communication network (80) being operated as a virtual TSN node. The virtual TSN node (80) is connected to a plurality of TSN nodes (70a, 70b). The method (500) is performed by a device side TSN translator, DS-TT (20), associated with one or more User Equipments, UEs (30), connected to a network node (40a) in the wireless communication network (80) or a network side TSN translator, NW-TT (75), associated with a User Plane Function, UPF (46), of a core network (60) connected to the network node (40a). The method (500) comprises receiving (502), from the TSN system (100), one or more generalized Precise Timing Protocol, gPTP, frames, each gPTP frame comprising a time stamp indicating time reference information. The method (500) comprises evaluating (504) the time reference information in the one or more gPTP frames. The method (500) comprises detecting (506) injection of the false timestamp in the time sensitive communication in accordance with the evaluation.

Corresponding DS-TT/NW-TT, and computer program products are also disclosed.

### TECHNICAL FIELD

The present disclosure relates generally to the field of Time Sensitive Networking, TSN, systems. More particularly, it relates to method, device side TSN translator, DS-TT/network side TSN translator, NW-TT, and computer program products for providing time synchronization between TSN entities of a TSN system.

### BACKGROUND

An automation industry is undergoing a digital transformation towards the “Fourth Industrial Revolution” (Industry 4.0), which involves smart manufacturing. Flexible connectivity infrastructure provided by the automation industry is a key enabler for manufacturing to interconnect machines, products and all kinds of other devices in a flexible, secure, and consistent manner.

Communication technology enablers for the digital transformation of the automation industry are Time Sensitive Networking, TSN, system (TSN network) on a wireline side, and a Third Generation Partnership Project, 3GPP, Fifth Generation, 5G, network on a wireless side. The TSN system is based on the Institute of Electrical and Electronics Engineers, IEEE 802.1 and 802.3 standard. The TSN system provides deterministic services through IEEE 802.3 networks, for example, time synchronization, guaranteed low latency transmissions and high reliability. The 5G network, an alternative to a wired connectivity solution supports communication with unprecedented reliability and very low latency, as well as massive Internet of Things, IoT, connectivity. Thus, the TSN system and the 5G network are considered as complementary technologies in providing deterministic communication services, thereby paying the way towards future advanced manufacturing systems and other vertical areas. Also, the TSN system and the 5G network are essential for network convergence that is a support of all kinds of communication services via a same network infrastructure. Therefore, the TSN system can be integrated to the 5G network for supporting the deterministic/time sensitive communication services (that require deterministic reliable and low latency communications) over heterogeneous infrastructure and multiple application domains required for the network convergence.

With the integration of the TSN system to the 5G network, the 5G network is deployed as a set of IEEE compliant virtual TSN nodes (also be referred to as virtual TSN bridges). The virtual-TSN node can be connected to TSN nodes (also be referred to wired TSN nodes/bridges). The 5G network comprises a 5G core network and a Radio Access Network, RAN. A User Plane Function, UPF, of the 5G core network acts as a gateway to the TSN system. The RAN spans over a production plant to provide wireless connectivity to one or more User Equipments, UEs.

The 5G network/virtual TSN node defines several gateways between the TSN system and the 5G network. The gateways include a TSN Application Function, AF, device side TSN translators, DS-TTs on the UEs, and network side TSN translators, NW-TT on the UPF. The TSN AF connects a Centralized Network Controller, CNC, a Centralized User Configuration, CUC and a 5G control plane.

TSN requirements introduce new vulnerabilities in the integrated TSN-5G network, which needs to be addressed. Since a time synchronization is a base of a TSN time-driven mechanism, for example, precise timing for IEEE 802.1Qbv scheduled for traffic forwarding, any Denial of Service attack on the time synchronization is very effective. The Denial of Service attack easily perturbs the required time synchronization on devices/entities of the TSN system, which can result in serious service malfunction. A significance of the Denial of Service attack is also valid in the integrated TSN-5G network, wherein reference time information in TSN messages is typically arriving from one or more the wired TSN nodes of the TSN system. Denial of Service attack may be determined by detecting false timestamp/reference time information in time sensitive communication.

### SUMMARY

It is important to provide time synchronization between TSN entities/peer entities of the TSN system by detecting injection of the false timestamp in the time sensitive communication. However, there is no mechanism available for detecting injection of the false timestamp in the time sensitive communication.

Consequently, there is a need for an improved method and arrangement for detecting injection of the false timestamp in time sensitive communication, for providing time synchronization between the TSN entities of the TSN system that alleviates at least some of the above-cited problems.

It is therefore an object of the present disclosure to provide a method, a device side TSN translator, DS-TT, or a network side TSN translator, NW-TT, and a computer program product for detecting injection of a false timestamp in time sensitive communication, to mitigate, alleviate, or eliminate all or at least some of the above-discussed drawbacks of presently known solutions.

This and other objects are achieved by means of a method, a device side TSN translator, DS-TT, or a network side TSN translator, NW-TT, and a computer program product as defined in the appended claims. The term exemplary is in the present context to be understood as serving as an instance, example or illustration.

According to a first aspect of the present disclose, a method for providing time synchronization between Time-Sensitive Networking, TSN, entities of a TSN system is provided. The TSN system is integrated to a wireless communication network and the wireless communication network is operating as a virtual TSN node. The method is performed by a device side TSN translator, DS-TT, associated with one or more User Equipments, UEs, connected to a network node in the wireless communication network or a network side TSN translator, NW-TT, associated with a User Plane Function, UPF, of a core network connected to the network node. The method comprises receiving, from the TSN system, one or more generalized Precise Timing Protocol, gPTP, frames, each gPTP frame comprising a time stamp indicating time reference information. The method comprises evaluating the time reference information in the one or more gPTP frames. The method comprises detecting injection of the false timestamp in the time sensitive communication in accordance with the evaluation.

In some embodiments, the step of evaluating the time reference information in the one or more gPTP frames comprises receiving standard time reference information from an authenticated time source of the wireless communication network. The method comprises estimating a drift between the time reference information in each gPTP frame and the standard time reference information.

In some embodiments, the step of detecting injection of the false timestamp in the time sensitive communication in accordance with the evaluation comprises determining whether the estimated drift between the time reference information in each gPTP frame and the standard time reference information is greater than a predefined number of previously estimated drifts. When it has been determined that the estimated drift is greater than the predefined number of previously estimated drifts, the method comprises detecting injection of the false timestamp in the time sensitive communication.

In some embodiments, the step of evaluating the time reference information in the one or more gPTP frames comprises determining a frequency of the one or more gPTP frames being arrived at the DS-TT and the NW-TT.

In some embodiments, the step of detecting injection of the false timestamp in the time sensitive communication in accordance with the evaluation comprises determining whether the frequency of the one or more gPTP frames being arrived at the DS-TT and the NW-TT are same. When it has been determined that the frequency of the one or more gPTP frames being arrived at the DS-TT and the NW-TT are not same, detecting injection of the false timestamp in the time sensitive communication.

In some embodiments, the step of evaluating the time reference information in the one or more gPTP frames comprises detecting replication of the one or more gPTP frames comprising the same time reference information.

In some embodiments, the step of detecting injection of the false timestamp in the time sensitive communication in accordance with the evaluation comprises determining whether replication of the one or more gPTP frames comprising the same time reference information is detected. When it has been determined that the replication is detected, the method comprises detecting injection of the false timestamp in the time sensitive communication.

In some embodiments, the method further comprises transmitting information indicating injection of the false timestamp in the time sensitive communication to at least one entity for enabling the at least one entity for performing one or more of: reconfiguration of the TSN system, reconfiguration of a transmission queue schedule of the NW-TT, and verification of different transmitter clocks belonging to different TSN domains of the TSN system for correlation.

According to a second aspect of the present disclosure, device side Time-Sensitive Networking, TSN, translator, DS-TT, associated with one or more User Equipments, UEs, connected to a network node in the wireless communication network or a network side TSN translator, NW-TT, associated with a User Plane Function, UPF, of a core network connected to the network node configured for providing time synchronization between TSN entities of a TSN system is provided. The TSN system is integrated to a wireless communication network and the wireless communication network is operating as a virtual TSN node. The virtual TSN node is connected to a plurality of TSN nodes. The DS-TT or the NW-TT is configured for receiving, from the TSN system, one or more generalized Precise Timing Protocol, gPTP, frames, each gPTP frame comprising a time stamp indicating time reference information. The DS-TT or the NW-TT is configured for evaluating the time reference information in the one or more gPTP frames. The DS-TT or the NW-TT is configured for detecting injection of the false timestamp in the time sensitive communication in accordance with the evaluation.

According to a third aspect of the present disclosure, there is provided a computer program product comprising a non-transitory computer readable medium, having thereon a computer program comprising program instructions. The computer program is loadable into a data processing unit and configured to cause execution of the method according to the first aspect when the computer program is run by the data processing unit.

In some embodiments, any of the above aspects may additionally have features identical with or corresponding to any of the various features as explained above for any of the other aspects.

An advantage of some embodiments is that alternative and/or improved approaches are provided for detecting injection of the false timestamp in the time sensitive communication, in order to provide time synchronization between the TSN entities/peer entities of the TSN system.

An advantage of some embodiments is that security attacks perturbing the time synchronization between the TSN entities of the TSN system may be detected based on detection of injection of the false timestamp in the time sensitive communication/end-to-end time service delivery chain of the TSN system integrated to the wireless communication network.

An advantage of some embodiments is that the injection of the false timestamp in the time sensitive communication is detected by evaluating time reference information carried by the gPTP frames with respect to the time reference information provided by the authenticated/trusted time source of the wireless communication network. Thus, the wireless communication network may be able to provide new functionality to detect the security attacks from the wired networks that is the TSN system.

Other advantages may be readily apparent to one having skill in the art. Certain embodiments may have none, some, or all of the recited advantages.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1 discloses an example of a Time Sensitive Networking, TSN, system integrated to a wireless communication network according to some examples;

FIG. 2 discloses an example of a TSN system integrated to a wireless communication network, which acts as a virtual TSN node according to some examples;

FIG. 3 discloses an example of a wireless communication network according to some examples;

FIGS. 4A and 4B disclose an example architecture of a TSN system integrated to a wireless communication network according to some examples;

FIG. 5 is a flowchart illustrating example method steps according to some examples;

FIG. 6 is a signaling diagram illustrating example signaling according to some examples;

FIG. 7 is a schematic block diagram illustrating an example apparatus according to some embodiments; and

FIG. 8 discloses an example computing environment according to some examples.

### DETAILED DESCRIPTION

Aspects of the present disclosure will be described more fully hereinafter with reference to the accompanying drawings. The apparatus and method disclosed herein can, however, be realized in many different forms and should not be construed as being limited to the aspects set forth herein. Like numbers in the drawings refer to like elements throughout.

The terminology used herein is for the purpose of describing particular aspects of the disclosure only, and is not intended to limit the invention. It should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Network node: As used herein, a network node (also be referred to as radio access node, radio network node, or the like) is any node in a Radio Access Network, RAN, of a wireless communication network that operates to wirelessly transmit and/or receive signals. Some examples of the network node include, but are not limited to, a base station (for example a New Radio, NR, base station, gNB, in a Third Generation Partnership Project, 3GPP, Fifth Generation, 5G, NR network or an enhanced or evolved Node B, eNB, in a 3GPP Long Term Evolution, LTE, network), a high-power or macro base station, a low-power base station (for example, a micro base station, a pico base station, a home eNB, or the like), a relay node, and so on.

Core network node: As used herein, a core network node is any type of node in a core network that implements a core network function. Some examples of the core network node include, for example, a Mobility Management Entity, MME, a Packet Data Network Gateway, P-GW, a Service Capability Exposure Function, SCEF, a Home Subscriber Server, HSS, or the like. Some other examples of the core network node include a node implementing an Access and Mobility Function, AMF, a User Plane Function, UPF, a Session Management Function, SMF, an Authentication Server Function, AUSF, a Network Slice Selection Function, NSSF, a Network Exposure Function, NEF, a Network Repository Function, NRF, a Policy Control Function, PCF, a Unified Data Management, UDM, and so on.

User Equipment, UE: As used herein, a UE (also be referred to as wireless device) is any type of device that has access to (i.e., is served by) a wireless communication network by wirelessly transmitting and/or receiving signals to a network node(s). Some examples of the UE are a target device, a device to device, D2D, UE, a machine type UE, a UE capable of machine to machine, M2M, communication, personal digital assistant, PDA, tablet, mobile terminals, smart phone, laptop embedded equipped, LEE, laptop mounted equipment, LME, universal serial bus, USB, dongles, UE category M2, ProSe UE, and so on.

Note that the description given herein focuses on a 3GPP wireless communication network and, as such, 3GPP terminology or terminology similar to 3GPP terminology is oftentimes used. However, the concepts disclosed herein are not limited to a 3GPP system.

Embodiments of the present disclosure will be described and exemplified more fully hereinafter with reference to the accompanying drawings. The solutions disclosed herein can, however, be realized in many different forms and should not be construed as being limited to the examples set forth herein.

It will be appreciated that when the present disclosure is described in terms of a method, it may also be embodied in one or more processors and one or more memories coupled to the one or more processors, wherein the one or more memories store one or more programs that perform the steps, services and functions disclosed herein when executed by the one or more processors.

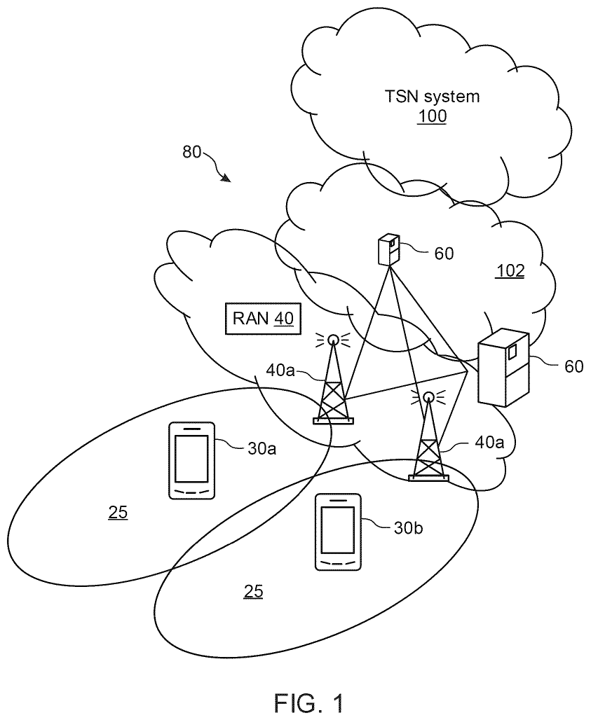

FIG. 1 discloses an example of a Time Sensitive Networking, TSN, system, 100 integrated to a wireless communication network 80. As depicted in FIG. 1, the TSN system 100 may be integrated with the wireless communication network 80 to provide converged communication on a same network infrastructure for a wide range of services, for example, time sensitive applications that require deterministic, reliable and low latency communications.

The TSN system (also be referred to as TSN network) 100 is based on the Institute of Electrical and Electronics Engineers, IEEE 802.1 and 802.3 Ethernet standard. The TSN system may provide deterministic services through IEEE 802.3 networks, for example, time synchronization, guaranteed low latency transmissions and high reliability.

The wireless communication network (also be referred to wireless communication system, cellular communication network/system, or the like) may be a wireless network, for example, a Fifth Generation, 5GS, network, a Long Term Evolution, LTE, network, an Evolved Universal Terrestrial Radio Access Network, E-UTRAN, a Wideband Code Division Multiple Access, WCDMA, network, a Global System for Mobile communications, GSM, network, a Worldwide Interoperability for Microwave Access, WiMAX, or any other future generation network.

The wireless communication network 80 comprises a Radio Access Network, RAN, 40 and a core network, CN, 60. The wireless communication network 80 may use a number of different Radio Access Technologies, RATs, such as LTE, LTE-Advanced, 5G, WCDMA, GSM/Enhanced Data rate for GSM Evolution, EDGE, WiMAX, Ultra Mobile Broadband, WMB, or the like.

The RAN 40 comprises one or more network nodes 40a, each providing radio coverage over one or more geographical areas, such as cells 25 supporting the one or more RATs. In some examples, the network node 40a may be a radio access node such as a radio network controller, an access point such as a Wireless Local Area Network, WLAN, access point or an Access Point Station, AP STA, an access controller, a base station, a base transceiver station, an Access Point base station, a base station router, a transmission arrangement of a radio base station, a standalone access point, or any other unit of the RAN capable of serving one or more User Equipments, UEs 30a, 30b, in the cell/service area. Examples of the base station may include, a gNodeB, gNB, an evolved Node B, eNB, and so on.

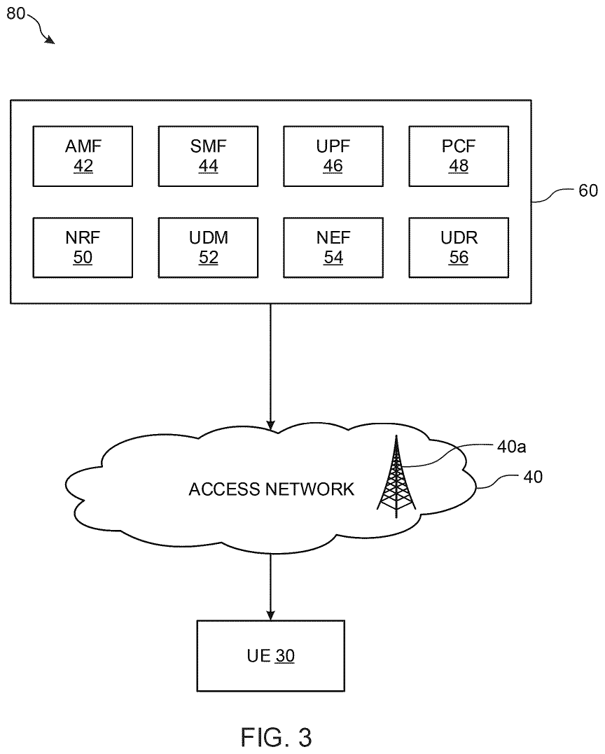

The CN 60 comprises a core network node. The core network node may be configured to communicate with the network node 40a via an interface, for example, an S1 interface. Examples of the core network node may include, a Mobility Management Entity, MME, an Operation and Management, O&M, node, an Operation, Administration and Maintenance, OAM, node, an Operations Support Systems, OSS, node, a Self-Organizing Network, SON, node, a Packet Data Network Gateway, P-GW, a Service Capability Exposure Function, SCEF, a Home Subscriber Server, HSS, or the like. The core network node may further be a distributed node comprised in a cloud 102. The core network node may further include a node implementing network functions of the CN 60 such as but are not limited to, an Access and Mobility Function, AMF, a User Plane Function, UPF, a Session Management Function, SMF, an Authentication Server Function, AUSF, a Network Slice Selection Function, NSSF, a Network Exposure Function, NEF, a Network Repository Function, NRF, a Policy Control Function, PCF, a Unified Data Management, UDM, and so on. The network functions of the CN 60 are described in detail in conjunction with FIG. 3.

In the wireless communication network 80, the one or more UEs 30a and 30b (collectively referred to as UE 30) may communicate with the CN 60 via the network nodes 40a of the RAN 40. Examples of the UE 30 may include, a wireless device, a mobile station, a non-access point, non-AP, station, STA, a wireless terminal, or the like. It should be understood by those skilled in the art that “wireless device” is a non-limiting term, which means any terminal, a wireless communication terminal, a User Equipment, a Mobile Type Communication, MTC, device, a Device to Device, D2D, terminal, or a node for example, a smart phone, a laptop, a mobile phone, a sensor, a relay, a mobile tablet, or even a base station communicating within the cell.

The UE 30 may be located in the cell 25 of the network node 40a, which is referred to as a serving cell and the cell of other network nodes may be referred to as neighbouring cells for the UE 30. Although the network node 40a, in FIG. 1, is only providing a serving cell 25, the network node 40a may further provide one or more neighbouring cells to the serving cell 25.

The UE 30 (also be referred to as first end station) may be connected to one or more end stations such as one or more second end stations. The second end station may include, but are not limited to, robots, a factory floor, or the like.

The wireless communication network 80 may according to some embodiments herein communicate with one or more nodes in the TSN system 100. The TSN system 100 may be connected to one or more end stations, such as, the second end stations.

According to some embodiments herein, with the integration of the TSN system 100, the wireless communication network 80 operates as a TSN virtual node (also be referred to as TSN virtual bridge, virtual wireless bridge, or the like).

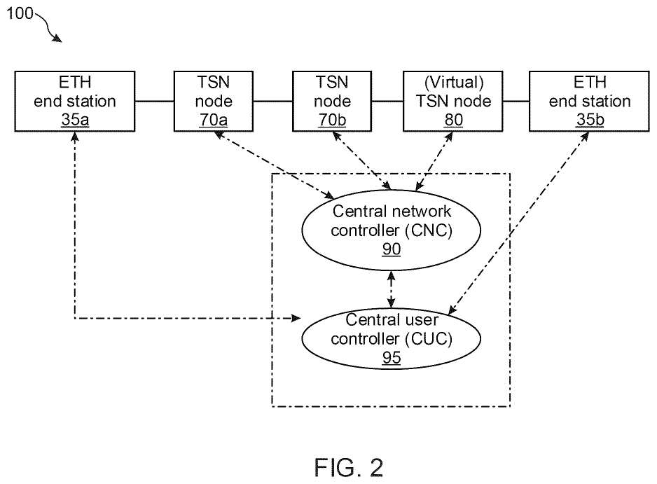

FIG. 2 discloses an example of the TSN system 100 integrated to the wireless communication network 80, wherein the wireless communication network 80 operates as the virtual TSN node. The TSN system 100 comprises one or more TSN nodes. For simplicity, the TSN system 100 comprising TSN nodes 70a and 70b is depicted in FIG. 2. The TSN nodes 70a and 70b may be wired TSN nodes (also be referred to as wired nodes, wired TSN bridges, or the like). With the integration of the TSN system 100 to the wireless communication network 80, the TSN system 100 may comprise the virtual TSN node 80. The virtual TSN node 80 referred herein may be the wireless communication network 80 or the virtual TSN node 80 may be a node implemented by the wireless communication network 80.

The TSN nodes 70a and 70b, and the virtual TSN node 80 may be connected to one or more end stations, for example, second end stations, which suppose to exchange time sensitive communication. The time sensitive communication may comprise TSN streams or TSN packets, or TSN flows to be exchanged between the end stations. As depicted in FIG. 2, the TSN node 70a may be connected to an end station 35a and the virtual TSN node 80 may be connected to an end station 35b. Examples of the end stations 35a and 35b may include, but are not limited to, robots, a factory floor, or the like. The end stations 35a and 35b may be connected to the UEs associated with the virtual TSN node 80 through the TSN nodes 70a/70b (not shown).

In some examples, the TSN nodes 70a and 70b, the virtual TSN node 80, and the end stations 35a and 35b may be configured in a static configuration setup or a centralized network configuration setup. In the static configuration setup, the TSN nodes 70a and 70b, the virtual TSN node 80, and the end stations 35a and 35b may be configured during network setup. In the centralized network configuration setup, a Centralized Network Controller, CNC, 90 (also be referred to as centralized network configuration) may configure the TSN nodes 70a and 70b, and the virtual TSN node 80 for TSN streams (data packets exchanged between the end stations through the TSN nodes 70a and 70b and the virtual TSN node 80). The CNC 90 may be adapted for configuring network resource reservations for the TSN nodes 70a and 70b, and the virtual TSN node 80. The CNC 90 may also be adapted for coordinating any changes to the configured network resource reservations with any new reservations. The network resource reservations may be made or requested by the end stations 35a and 35b. In the fully centralized network configuration setup where both network and user configuration are centralized, the CNC may receive requirements of data flows from a Centralized User Controller, CUC, 95 (also be referred to as centralized user configuration) and then compute a route, and a time schedule required for end-to-end, E2E, transmission for each TSN stream. The CNC may also configure the TSN nodes 70a and 70b and the virtual TSN node 80 in accordance with the computed route and time schedule.

In some embodiments, the wireless communication network acting as the virtual TSN node 80 may obtain, from a controller of the TSN system (not shown), one or more TSN Quality of Service, QoS, parameters and information related to a traffic pattern for the virtual TSN node 80. The TSN QoS parameters may be mapped to QoS policy(ies) and/or rules in the wireless communication network and applied in the wireless communication network in order to satisfy TSN QoS requirements for the virtual TSN node. In addition, at least some of the information related to the traffic pattern for the virtual TSN node may be provided to an edge node to achieve the desired traffic pattern. In some examples, the edge node may be the UPF of the CN for uplink direction or the UE for downlink direction.

In some other embodiments, the wireless communication system operating as the virtual TSN node 80 may obtain, from the controller of the TSN system, information related to the traffic pattern for the preceding TSN node 70b (the TSN node that precedes the virtual TSN node 80 in a direction of TSN traffic flow). At least some of the information related to the traffic pattern for the preceding TSN node 70b may be provided to the one or more network nodes of the wireless communication system for radio optimization. Components of the wireless communication network operating as the virtual TSN node 80 is described in detail in conjunction with FIG. 3.

FIG. 3 discloses the wireless communication network 80 operating as the virtual TSN node, while integrated to the TSN system. As depicted in FIG. 3, the wireless communication network 80 comprises the RAN 40, the CN 60, and the UE 30. The RAN 40 includes the network node 40a.

The network node 40a may be directly connected to the UE 30. The network node 40a may include a group of a plurality of base stations including a base station, and the plurality of base stations may perform communication via an interface. The base station may have a structure having a central unit, CU, and a distributed unit, DU, separated from each other. In this case, one CU may control a plurality of DUs. The base station may be referred to as an access point, AP, a next-generation node i.e., a gNB, a 5th generation node, a wireless point, or a transmission/reception point, TRP, or the like. The UE 30 accesses the RAN 40 and communicates with the network node 40a through a wireless channel. The UE 30 may be a user equipment, UE, a mobile station, a subscriber station, a remote terminal, a wireless terminal or the like.

The CN 60, which is the network that manages or controls the RAN 40 and processes data and control signals for the UE 30, transmitted and received via the RAN 40. The CN 60 may perform various functions including control of a user plane and a control plane, processing of mobility, management of subscriber information, charging, and interworking with other types of systems such as, LTE, system.

To perform the various functions described above, the CN 60 may include a plurality of functionally separated entities (i.e., core network nodes) having different network functions. For example, the network functions may include an AMF 42, a SMF 44, a UPF 46, a PCF 48, a network repository function, NRF 50, a UDM 52, a NEF 54, and a unified data repository UDR 55. Although, not shown in FIG. 3, the CN 60 may interwork with a TSN Application Function, AF, the CNC and the TSN system. In some examples, the CN 60 may be referred as a 5th generation, 5G, core, 5GC, which is a core network of a 5G system.

The UE 30 connected to the RAN 40 may accesses the AMF 42, which performs a mobility management function of the CN 60. The AMF 42 is a function or a device that is responsible for both access to the RAN 40 and the mobility management of the UE 30. The SMF 44 is a network function that manages a session. The AMF 42 may be connected to the SMF 44, and the AMF 42 may route session-related messages of the UE 30 to the SMF 44. The SMF 44 may be connected to the UPF 46 to allocate a user plane resource to be provided to the UE 30 and establish a tunnel for transmitting data between the network node 40a and the UPF 46. The SMF 44, as a main entity managing a PDU session, may be responsible for QoS setting/update for QoS flows in the PDU session. The PCF 48 may control information associated with a policy and charging of a session used by the UE 30. The NRF 50 may be connected to all the network functions. Each network function is registered with the NRF 50 when starting to run in the operator network, so as to inform the NRF 50 that the network function is running in the wireless communication network 80. The UDM 52, as a network function may perform a role similar to a home subscriber server, HSS, of a 4G network, and store subscription information of the UE 30 or context information used by the UE 30 in the network.

The NEF 54 may serve to connect a third party server to the network function in the wireless communication network 80. In addition, the NEF 54 may serve to provide data to the UDR 56 and to update or obtain data. The UDR 56 may serve to store subscription information of the UE 30, store policy information, store data exposed to the outside, or store information necessary for a third-party application. Further, the UDR 56 may also serve to provide stored data to other network functions.

The UDM 52, PCF 48, SMF 44, AMF 42, NRF 50, NEF 54, and UDR 56 may be connected to a service-based interface. Services or application programing interfaces, APIs, provided by these network functions are used by other network functions and thus may exchange control messages with each other. For example, when the AMF 42 delivers a session-related message to the SMF 44, a service or API called Nsmf_PDUSession_CreateSM Context may be used.

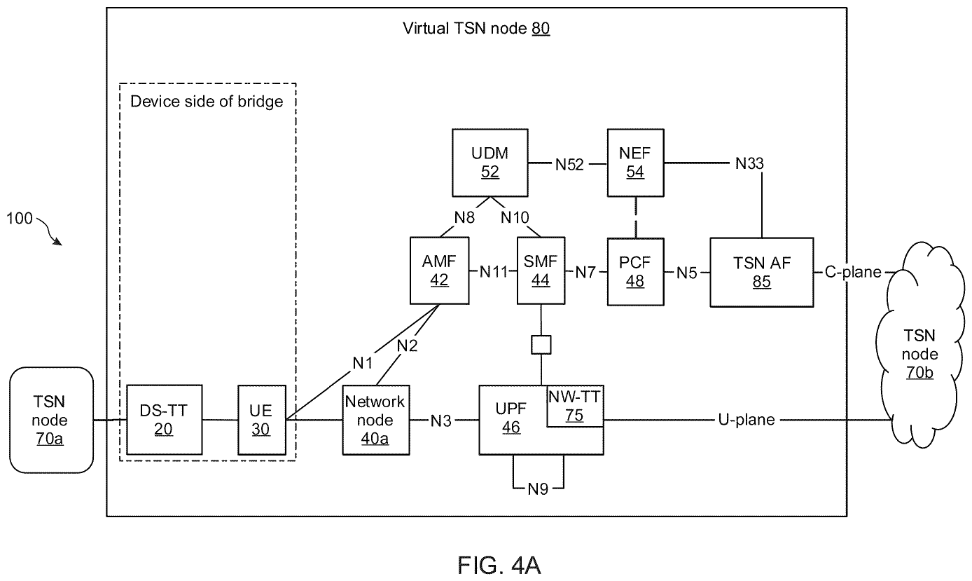

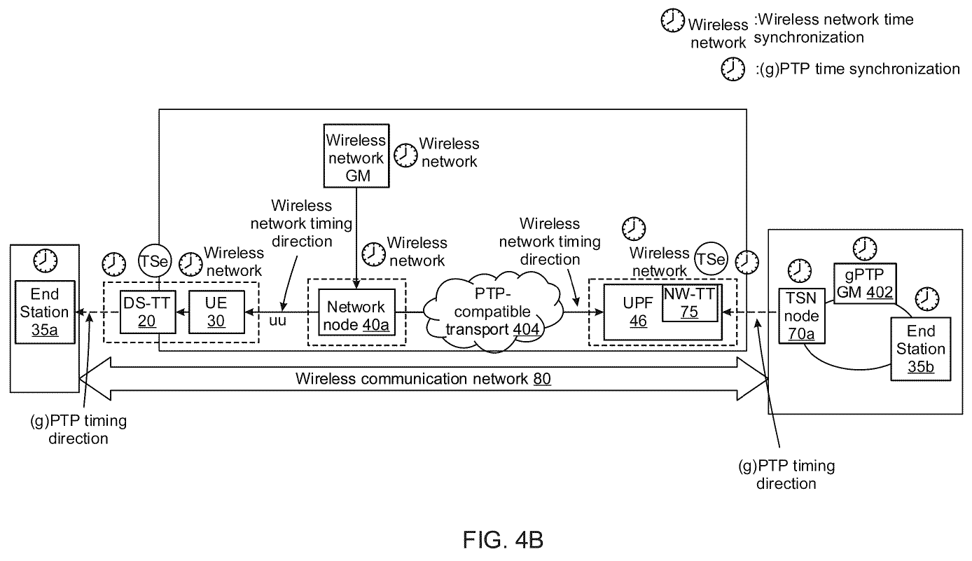

FIGS. 4A and 4B disclose an example architecture of the TSN system 100 integrated to the wireless communication network 80 in which embodiments of the present disclosure may be implemented. For a seamless integration between the wireless communication network 80 and the TSN system 100, the wireless communication network 80 and the TSN system 100 may interoperate in a transparent manner to minimize impact on other TSN entities.

With the integration of the TSN system 100 to the wireless communication network 80, the TSN system 100 comprises the one or more TSN nodes/wired TSN bridges 70a and 70b, and the virtual TSN node 80. The TSN nodes 70a and 70b and the virtual TSN node 80 are described in detail in conjunction with FIG. 2.

The virtual TSN node/wireless communication network 80 comprises the RAN and the CN. The RAN comprises the network node 40a. The CN comprises network functions such as, the AMF 42, the SMF 44, the PCF 48, the NEF 54, the UDM 52, the UPF 46, or the like. All these network functions of the CN are described in detail in conjunction with FIG. 3.

In some examples, the virtual TSN node/wireless communication network 80 may define several gateways, which enable the virtual TSN node 80 to communicate with the TSN system 100 and the CNC 90. The gateways may include the TSN AF 85, a device side TSN translator, DS-TT, 20, on the UE 30, and a network side TSN translator, NW-TT, 75 on the UPF 46 of the CN. TSN ingress ports and egress ports may be provided via the DS-TT 20 on the UE 30 and via the NW-TT 75 on the CN.

The TSN AF 85 may be configured to connect the CNC 90, the CUC 95 entities and a control plane, C-plane. In some examples, the TSN AF may be associated with the CN. In some examples, the TSN AF may be a third party entity outside an operator network or an entity inside the operator network. For example, the TSN AF 85 may be an entity within the CN, which is inside the operator network, since the CN corresponds to an essential function for supporting TSN. The TSN AF 85 may derive information about a TSN stream from information provided by the CNC 90 in the form of bridge management information, and possibly using other configuration data. The TSN AF 85 may determine QoS parameters including: a priority, a Maximum Burst Size, a delay and a Maximum Bitrate, and may provide these parameters to the PCF 48.

In some examples, the DS-TT 20 and the NW-TT 75 may support hold and forward functionality of purpose of de-jittering, and per-stream filtering and policing as defined in clause 8.6.5.1 of IEEE std 802.1Q. The DS-TT 20 may optionally support link layer connectivity discovery and reporting as defined in IEEE std 802.1AN for discovery of the end stations attached to the DS-TT 20. The NW-TT 75 may support link layer connectivity discover and reporting as defined in IEEE std 802.1AB for discovery of the end stations attached to the NW-TT 75. If the DS-TT 20 does not support the link layer connectivity discovery and reporting, the NW-TT 75 may perform the link layer connectivity discovery and reporting as defined in IEEE std 802.1AB for discovery of the end stations attached to the DS-TT 20 on behalf of the DS-TT 20.

Further, as depicted in FIG. 4B, the CNC 90 may be configured to configure and operate the TSN nodes 70a and 70b of the TSN system 100 and the virtual TSN node 80. Configuring, by the CNC, the TSN nodes 70a and 70b of the TSN system 100 and the virtual TSN node 80 are described in detail in FIG. 2.

Further, as depicted in FIG. 4B, for supporting a time synchronization service, the wireless communication network 80/virtual TSN node 80 may be configured to operate in one or more Precision Time Protocol, PTP, instances and to operate in one of the following modes (if supported) for each PTP instance:
as time-aware system as described in IEEE std 802.1AS; and
as boundary clock as described in IEEE std 1588, provisioned by profiles supported by the 3GPPP specification including a SMTE profile for use of IEEE std 1588 PTP in professional broadcast application ST2059-2:2015. In some examples, via proper configuration of IEEE std 1588 data set members, an internal system clock of the wireless communication network 80 may act as a time source for PTP grandtime transmitter function for connected networks in case of the above described modes. In some examples, when the internal system clock of the wireless communication network 80 is the time source for the PTP grandtime transmitter for the connected networks, the UE 30 may not be required to receive generalized Precision Time Protocol, gPTP, messages or PTP messages over user plane. The UE 30, and the DS-TT 20 may use timing information from the wireless communication network 80 (for example, 5G timing information) and generate the necessary gPTP or PTP message for the end station, if needed as follows:
as peer-to-peer transparent clock as described in IEEE std 1588, provisioned by the profiles supported by the 3GPP specification including the SMPTE profile for use of IEEE std 1588 PTP in professional broadcast applications ST2059-2:2015; or
as end-to-end transparent clock as described in IEEE std 1588, provisioned by the profiles supported by the 3GPP specification including the SMPTE profile for use of IEEE std 1588 PTP in professional broadcast applications ST2059-2:2015.

The DS-TT 20 and the NW-TT 75 at an edge of the wireless communication network 80 may support IEEE std 802.1AS or other IEEE std 1588 profiles' operations respective to the configured mode of operation. The UE 30, the network node 40a, the UPF 46, the NW-TT 75, and the DS-TT 20 may be synchronized with a wireless communication network grand master (also be referred to as wireless network GM, 5G GM, 5G internal system clock, or the like), which may serve to keep these network elements synchronized.

The TSN system integrated to the wireless communication network 80 supports two synchronizations, a wireless communication network clock synchronization (also be referred to as wireless network clock synchronization, 5G clock synchronization, or the like) and a (g)PTP domain synchronization. For the wireless network clock synchronization, an (5G) Access Stratum-based time distribution may be used and also distributed to the UE 30. The Access Stratum-based time distribution over a radio interface towards the UE 30 is as specified in 3GPP TS 38.331. The Access Stratum-based time distribution may be used to either further distribute the wireless network timing to the end stations connected to the UE (using implementation-specific means) or to support the operation of a (g)PTP-based time distribution. The (g)PTP based time distribution may be used for (g)PTP domain synchronization. The (g)PTP based time distribution may provide timing among entities in a (g)PTP domain. The (g)PTP relies on the Access Stratum-based time distribution to synchronize the UE 30/DS-TT 20 and on wireless network/5G time synchronization to synchronize the network node 40a (which, in turn, may synchronize the DS-TT 20) and the NW-TT 75. The network node 40a may be required to be synchronized to the wireless network GM/wireless network GM clock

The wireless network GM may be available to all user plane nodes in the wireless communication network 80. The UPF 46 and the NW-TT 75 may obtain the wireless network GM via an underlying PTP compatible transport network 404 with mechanisms outside the scope of 3GPP. The wireless network GM may be available to the UE 30 with signalling of time information related to absolute timing of radio frames as described in TS 38.331. The wireless network GM may be available to the DS-TT 20 by the UE 30.

For downlink time synchronization, upon reception of a downlink gPTP frame (also be referred to as gPTP message, gPTP packet, or the like) from the NW-TT 75 in a follower state, the NW-TT 75 creates an ingress timestamping, Tsi for each gPTP event (Sync) message and uses cumulative rate ratio received inside a gPTP message payload (carried within the Sync message for one step operation or Follow_up message for a two-step operation) to calculate a link delay from upstream TSN node (gPTP entity connected to the NW-TT 75) expressed in a TSN Grand Master, GM, time as specified in IEEE std 802.1AS. The NW-TT 75 may then calculate a new cumulative rate Ratio (i.e., a cumulative rate Ratio of the wireless communication network as specified in IEEE std 802.1AS and may modify the gPTP message payload (carried within the Sync message for the one-step operation or the Follow-up message for the two-step operation) as follows:
adds a link delay from the upstream TSN node in the TSN GM to a correction field;
replaces the cumulative rate Ratio received from the upstream TSN node with a new cumulative rate Ratio; and
adds Tsi in a suffix field of the gPTP frame as described in clause H.2.

The UPF 46/NW-TT 75 may use an ingress port number of the NW-TT 75, and domain Number in the received gPTP frame to assign the gPTP frame to a PTP instance in the NW-TT 75. If the NW-TT 75 does not have matching PTP instance, the UPF 46/NW-TT 75 discards the gPTP frame. The UPF 46/NW-TT 75 may then forward the gPTP frame from the TSN system 100 to PTP ports in the DS-TT 20 in a Leader state within this PTP instance via Protocol Data Unit, PDU, sessions terminating in the UPF 46 that the UE 30 has established to the TSN system 100. The UPF 46/NW-TT 75 may also forward the gPTP frame to the PTP ports in the NW-TT 75 in the Leader state within the PTP instance. All the gPTP frames may be transmitted on a QoS flow that complies with a residence time upper bound requirement specified in IEEE std 802.1AS.

The UE 30 may receive the gPTP frames and forward the gPTP frames to the DS-TT 20. The DS-TT 20 may then create an egress timestamping, Tse, for the gPTP event (Sync) message for external TSN working domains. A difference between the Tsi and Tse may be considered as a calculated residence time spent within the wireless communication network 80 for the gPTP messages expressed in the wireless network time. The DS-TT 20 may use a rate Ratio contained inside the gPTP message payload (carried within the Sync message for the one-step operation or the Follow_ up message for the two-step operation) to convert a residence time spent within the wireless communication network 80 in the TSN GM time. After converting, the DS-TT 20 may modify the payload of the gPTP message that the DS-TT 20 transmits towards the downstream TSN node (gPTP entity connected to the DS-TT 20) as follows:
adds the calculated residence time expressed in the TSN GM to the correction field; and
removes the suffix field that contains the Tsi.

If the ingress DS-TT 20 has indicated a support of IEEE stad 802.1AS PTP profiles as described in clause K.2.1 and the network node 40a has configured a PTP instance with IEEE std 802.1AS PTP profile for the ingress DS-TT 20, the ingress DS-TT 20 may perform the following operations for received uplink gPTP messages for the PTP instance:
adds the link delay from the upstream TSN node (gPTP entity connected to the DS-TT 20) in the TSN GM time to the correction field;
replaces the cumulative rate Ratio received from the upstream TSN node (gPTP entity connected to the DS-TT 20) with the new cumulative rate Ratio; and
adds Tsi in the suffix field of the gPTP frame.

The UE 30 transparently forwards the gPTP frame from the DS-TT 20 to the UPF 46/NW-TT 75. If the ingress DS-TT 20 is in a passive state, the UPF 46/NW-TT 75 discards the gPTP message. If the ingress DS-TT 20 is in a follower state, the UPF 46/NW-TT 75 forwards the gPTP messages as follows:
in the case of synchronizing end stations behind the NW-TT 75, the egress port may be in the UPF 46/NW-TT 75. For the received uplink gPTP frames, the egress UPF/NW-TT 75 may add the calculated residence time expressed in the TSN GM to the correction field and remove the suffix filed that contains the Tsi; and
in the case of synchronizing TSN end stations being the DS-TT, the egress TT may be the DS-TT 20 of the other UE 30. The UPF 46/NW-TT 75 may use the port number of the ingress DS-TT 20, and domain number in the received gPTP frame to assign the gPTP message to a PTP instance in the NW-TT 75. If the NW-TT 75 does not have a matching PTP instance, the UPF 46/NW-TT 75 discards the gPTP frame. The UPF 46/NW-TT 75 then may forward the received uplink gPTP message to the PTP ports in the DS-TT 20 in the Leader state within the PTP instance. The egress DS-TT may perform same actions as the egress UPF 46/NW-TT 75 in the previous case.

If the PTP port is in the egress TT, then an egress timestamping, Tse, for the PTP event (i.e., Sync) frames for external PTP network. A difference between the Tsi and Tse may be considered as the calculated residence time spent within the wireless communication network 80 for the PTP message expressed in the wireless network time.

The PTP port in the egress TT may then use the rate Ratio contained inside the PTP message payload (if available, carried within the Sync message for the one-step operation or the Follow_up message for the two-step operation) to convert the residence time spent within the wireless communication network 80 in the PTP GM time.

The PTP port in the egress TT may modify the payload of the PTP message (Sync message for the one-step operation or the Follow_Up message for the two-step operation) that the PTP port transmits towards the downstream PTP instance as follows:
adds the calculated residence time to the correction field; and
removes the suffix field of the PTP message that contains Tsi.

From the above description, it is evident that the time synchronization between end-end TSN entities of the TSN system is a base of the TSN time-driven mechanism. However, the time synchronization can be perturbed easily by any Denial of Service attacks. Thereby, resulting in serious service malfunction. The Denial of Service attack may be determined by detecting false timestamp/reference time information in time sensitive communication. However, there is no solution available to detect the false timestamp in the time sensitive communication.

Therefore, according to some embodiments of the present disclosure, the DS-TT 20 or the NW-TT 75 implements a method for detecting injection of a false timestamp in time sensitive communication to provide time synchronization between end-to-end TSN entities (for example, the TSN nodes 70a and 70b, the UE 30, the virtual network node 80, and so on) of the TSN system 100.

The DS-TT 20 or the NW-TT 75 receives, from the TSN system 100, one or more gPTP frames, each frame comprising a timestamp indicating time reference information. Upon reception of the one or more gPTP frames, the DS-TT 20 or the NW-TT 75 evaluates the time reference information in the one or more gPTP frames. In some examples, the one or more gPTP frames may be received from a time reference source/transmitter (i.e., gPTP GM 402) that belongs to the TSN system. In accordance with the evaluation, the DS-TT 20 detects injection of the false timestamp in the time sensitive communication. Thus, service attacks on the time synchronization of the TSN system may be determined based on the detection of the injection of the false timestamp in the time sensitive communication.

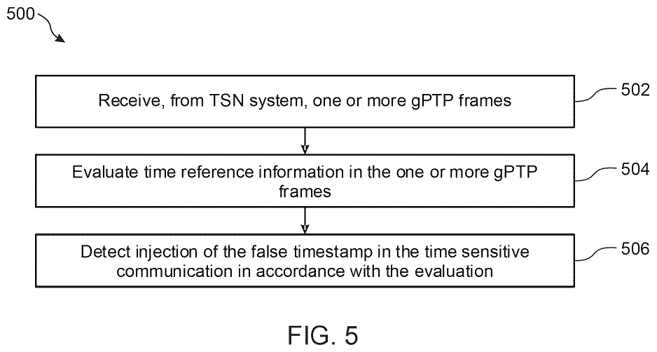

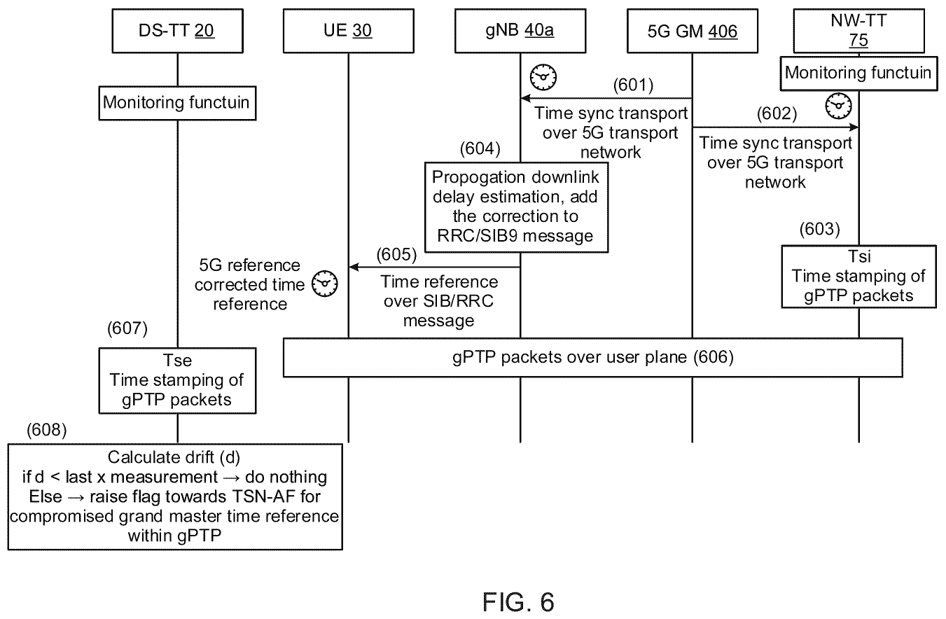

FIG. 5 is a flowchart illustrating example method steps of a method 500 performed for providing time synchronization between TSN entities of the TSN system. The TSN system is integrated to the wireless communication network being operated as the virtual TSN node. The virtual TSN node is connected to the plurality of TSN nodes. The method is performed by the DS-TT associated with the one or more UEs connected to the network node in the wireless communication network or the NW-TT associated with the UPF of the CN connected to the network node.

At step 502, the method 500 comprises receiving, from the TSN system 100, one or more gPTP frames. Each gPTP frame comprises a time stamp indicating time reference information. In some examples, the gPTP frames may deployed in the UPF and the UE as part of the NW-TT and the DS-TT, respectively. In some examples, the one or more gPTP frames may be received from a time reference source/transmitter (i.e., gPTP GM) that belongs to the TSN system.

At step 504, the method 500 comprises evaluating the time reference information of the one or more gPTP frames.

In some embodiments, the step 504 of evaluating the time reference information of the one or more gPTP frames may comprise receiving standard time reference information from an authenticated time source (i.e., the wireless network GM) of the wireless communication network. Upon receiving the standard time reference information, the method may comprise estimating a drift between the time reference information in each gPTP frame and the standard time reference information.

In some embodiments, the step 504 of evaluating the time reference information of the one or more gPTP frames may comprise determining a frequency of the one or more gPTP frames being arrived at the DS-TT and the NW-TT.

In some embodiments, the step 504 of evaluating the time reference information of the one or more gPTP frames may comprise detecting replication of the one or more gPTP frames comprising the same time reference information.

Upon evaluating the time reference information of the one or more gPTP frames, at step 506, the method 500 comprises detecting injection of the false timestamp in the time sensitive communication in accordance with the evaluation.

In some embodiments, the step 506 of detecting injection of the false timestamp in the time sensitive communication in accordance with the evaluation may comprise determining whether the estimated drift between the time reference information in each gPTP frame and the standard time reference information is greater than a predefined number of previously estimated drifts. When it has been determined that the estimated drift is greater than the predefined number of previously estimated drifts, detecting injection of the false timestamp in the time sensitive communication.

In some embodiments, the step 506 of detecting injection of the false timestamp in the time sensitive communication in accordance with the evaluation may comprise determining whether the frequency of the one or more gPTP frames being arrived at the DS-TT and the NW-TT are same. When it has been determined that the frequency of the one or more gPTP frames being arrived at the DS-TT and the NW-TT are not same, the method may comprise detecting injection of the false timestamp in the time sensitive communication.

In some embodiments, the step 506 of detecting injection of the false timestamp in the time sensitive communication in accordance with the evaluation may comprise determining whether replication of the one or more gPTP frames comprising the same time reference information is detected. When it has been determined that the replication is detected, detecting injection of the false timestamp in the time sensitive communication.

In some embodiments, the method 500 may further comprise transmitting information indicating injection of the false timestamp in the time sensitive communication to at least one entity for enabling the at least one entity for performing one or more of: reconfiguration of the TSN system, reconfiguration of a transmission queue schedule of the NW-TT, and verification of different transmitter clocks belonging to different TSN domains of the TSN system for correlation. In some examples, the entity may include one or more of: the CNC, the TSN AF, and the UPF. Thus, performing above described steps after dejecting injection of the false timestamp may help in achieving time synchronization between end-to-end TSN entities of the TSN system.

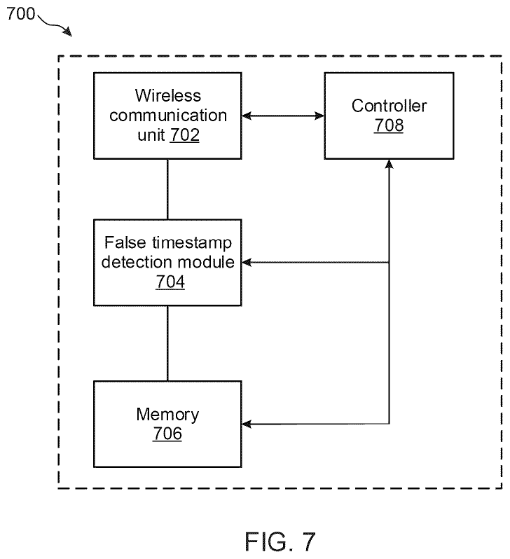

FIG. 7 is a signaling diagram illustrating example signaling for detecting injection of the false timestamp in the time sensitive communication. Embodiments herein describe detection of injection of the false timestamp in the time sensitive communication by considering the wireless communication network as a 5G network. The 5G network comprises a gNB 40a (an example of the network node 40a) and the CN. The UE 30 may be connected to the gNB 40a and may be associated with the DS-TT. The CN may comprise the UPF, which is associated with the NW-TT.

The 5G GM 406 transmits (601) a time synchronization (sync) transport message to the gNB 40a over a 5G transport network. The 5G GM 406 transmits (602) the time sync transport message/gPTP event (Sync) message to the NW-TT 75 over the 5G transport network. Upon reception of the time sync transport message, the NW-TT 75 performs (603) an ingress timestamping, Tsi, of gPTP frames. Details related to the ingress timestamping is described in detail in conjunction with FIG. 4B.

Upon reception of the time sync transport message, the gNB 40a performs (604) a propagation downlink delay estimation, and adds a correction to a Radio Resource Control, RRC, message or a System Information Block 9, SIB9 message. The gNB 40a transmits (605) the standard time reference information to the UE 30 over the SIB/RRC message. Thus, the UE 30 receives 5G corrected time reference information. Thereafter, the gPTP frames/packets may be exchanged between the UE 30 and the NW-TT 75 over a user plane. Upon reception of the gPTP frames, the NW-TT 75 may detect the injection of the false time stamp in the time sensitive communication of the TSN system using time reference information carried by the gPTP frames similar to the DS-TT 20 as described below.

Upon receiving the gPTP frames, the DS-TT 20 performs (607) an egress timestamping, Tse, of the gPTP frames. After performing the egress timestamping, the DS-TT 20 detects (608) whether the false timestamp is injected into time sensitive communication of the TSN system. For detecting injection of the false timestamp, the DS-TT 20 estimates the drift, d, indicating deviation of the time reference information carried by the gPTP frames from the standard time reference information/5G time reference information. The DS-TT 20 determines whether the estimated drift is greater than a predefined number of previously estimated drifts (for example, last x measurement). When it has been determined that the estimated drift is not greater than the predefined number of previously estimated drifts, the DS-TT 20 does not perform any action.

When it has been determined that the estimated drift is greater than the predefined number of previously estimated drifts, the DS-TT 20 detects injection of the false timestamp in the time sensitive communication. Upon detecting injection of the false timestamp, the DS-TT 20 raises a flag towards the TSN AF for compromised TSN GM time reference information within the gPTP frames.

FIG. 7 is an example schematic diagram showing an apparatus 700. The apparatus 700 may e.g. be comprised in the DS-TT or the NW-TT. The apparatus 700 is capable of detecting injection of a false timestamp in time sensitive communication of the TSN system and may be configured to cause performance of the method 500 for detecting injection of the false timestamp in the time sensitive communication.

According to at least some embodiments of the present invention, the apparatus 700 in FIG. 7 comprises one or more modules. These modules may e.g. be a wireless communication unit 702, a false timestamp detection module 704, a memory 706, and a controller 708. The controller 708, may in some embodiments be adapted to control the above mentioned modules. The wireless communication unit 702, the false timestamp detection module 704, the memory 706, as well as the controller 708, may be operatively connected to each other.

The controller 708 may be adapted to control the steps as executed by the DS-TT or the NW-TT. For example, the controller 708 may be adapted for detecting injection of the false timestamp in the time sensitive communication (as described above in conjunction with the method 500 and FIG. 5).

The false timestamp detection module 704 may be adapted to detect injection of the false timestamp in the time sensitive communication by evaluating time reference information carried by one or more gPTP frames.

The wireless communication unit 702 may be adapted to transmit information indicating injection of the false timestamp in the time sensitive communication to at least one entity for enabling the at least one entity for performing one or more of: reconfiguration of the TSN system, reconfiguration of a transmission queue schedule of the NW-TT, and verification of different transmitter clocks belonging to different TSN domains of the TSN system for correlation. In some examples, the entity may include one or more of: the CNC, the TSN AF, and the UPF.

The memory 706 may store at least one of: time reference information carried by the gPTP frames, information about the injection of the false timestamp in the time sensitive communication, and so on.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors, DSPs, special-purpose digital logic, and the like. The processing circuitry may be configured to execute program code stored in memory, which may include one or several types of memory such as read-only memory (ROM), random-access memory, RAM, cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the disclosure.

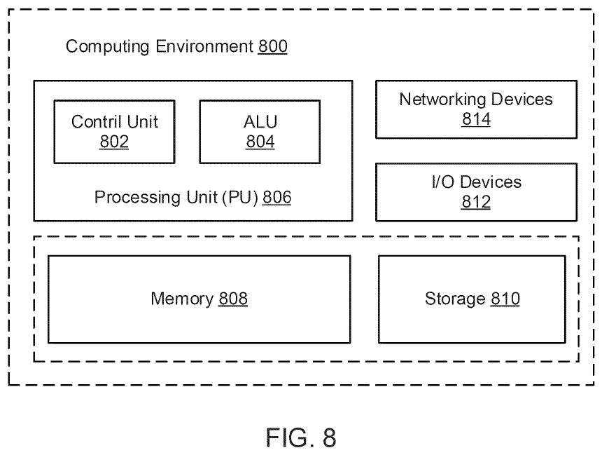

FIG. 8 illustrates an example computing environment 800 implementing a method and the apparatus, as described in FIGS. 5 and 7. As depicted in FIG. 8, the computing environment 800 comprises at least one data processing module 806 that is equipped with a control module 802 and an Arithmetic Logic Unit (ALU) 804, a plurality of networking devices 814 and a plurality Input output, I/O devices 812, a memory 808, a storage 810. The data processing module 806 may be responsible for implementing the method described in FIG. 5. For example, the data processing module 806 may in some embodiments be equivalent to the CPU/processor/controller of the apparatus described above in conjunction with the FIG. 7. The data processing module 806 is capable of executing software instructions stored in memory 808. The data processing module 1006 receives commands from the control module 802 in order to perform its processing. Further, any logical and arithmetic operations involved in the execution of the instructions are computed with the help of the ALU 804.

The computer program is loadable into the data processing module 806, which may, for example, be comprised in an electronic apparatus (such as a DS-TT or a NW-TT). When loaded into the data processing module 806, the computer program may be stored in the memory 808 associated with or comprised in the data processing module 806. According to some embodiments, the computer program may, when loaded into and run by the data processing module 806, cause execution of method steps according to, for example, any of the method illustrated in FIG. 5 or otherwise described herein.

The overall computing environment 800 may be composed of multiple homogeneous and/or heterogeneous cores, multiple CPUs of different kinds, special media and other accelerators. Further, the plurality of data processing modules 806 may be located on a single chip or over multiple chips.

The algorithm comprising of instructions and codes required for the implementation are stored in either the memory 808 or the storage 810 or both. At the time of execution, the instructions may be fetched from the corresponding memory 808 and/or storage 810, and executed by the data processing module 806.

In case of any hardware implementations various networking devices 814 or external I/O devices 812 may be connected to the computing environment to support the implementation through the networking devices 814 and the I/O devices 812.

The embodiments disclosed herein can be implemented through at least one software program running on at least one hardware device and performing network management functions to control the elements. The elements shown in FIG. 8 include blocks which can be at least one of a hardware device, or a combination of hardware device and software module.

1. A method for providing time synchronization between Time-Sensitive Networking, TSN, entities in a TSN system, the TSN system being integrated to a wireless communication network, the wireless communication network operating as a virtual TSN node, the method being performed by a device side TSN translator, DS-TT, associated with one or more User Equipments, UEs, connected to a network node in the wireless communication network or a network side TSN translator, NW-TT, associated with a User Plane Function, UPF, of a core network connected to the network node in the wireless communication network, the method comprising:
receiving, from the TSN system, one or more generalized Precise Timing Protocol, gPTP, frames, each gPTP frame comprising a time stamp indicating time reference information;
evaluating the time reference information in the one or more gPTP frames; and
detecting injection of the false timestamp in a time sensitive communication in accordance with the evaluation.

2. The method according to claim 1, wherein evaluating the time reference information in the one or more gPTP frames comprises:
receiving standard time reference information from an authenticated time source of the wireless communication network; and
estimating a drift between the time reference information in each gPTP frame and the standard time reference information.

3. The method according to claim 2, wherein detecting injection of the false timestamp in the time sensitive communication in accordance with the evaluation comprises:
determining whether the estimated drift between the time reference information in each gPTP frame and the standard time reference information is greater than a predefined number of previously estimated drifts; and
when it has been determined that the estimated drift is greater than the predefined number of previously estimated drifts, detecting injection of the false timestamp in the time sensitive communication.

4. The method according to claim 1, wherein evaluating the time reference information in the one or more gPTP frames comprises:
determining a frequency of the one or more gPTP frames being arrived at both the DS-TT and the NW-TT.

5. The method according to claim 4, wherein detecting injection of the false timestamp in the time sensitive communication in accordance with the evaluation comprises:
determining whether the frequency of the one or more gPTP frames being arrived at the DS-TT and the NW-TT are same; and
when it has been determined that the frequency of the one or more gPTP frames being arrived at the DS-TT and the NW-TT are not same, detecting injection of the false timestamp in the time sensitive communication.

6. The method according to claim 1, wherein evaluating the time reference information in the one or more gPTP frames comprises:
detecting replication of the one or more gPTP frames comprising the same time reference information.

7. The method according to claim 6, wherein detecting injection of the false timestamp in the time sensitive communication in accordance with the evaluation comprises:
determining whether replication of the one or more gPTP frames comprising the same time reference information is detected; and
when it has been determined that the replication is detected, detecting injection of the false timestamp in the time sensitive communication.

8. The method according to claim 1, further comprising transmitting information indicating injection of the false timestamp in the time sensitive communication to at least one entity for enabling the at least one entity for performing one or more of:
reconfiguration of the TSN system; and
reconfiguration of a transmission queue schedule of the NW-TT.

9. A Time-Sensitive Networking, TSN, system, comprising a device side TSN translator, DS-TT, associated with one or more User Equipments, UEs, connected to a network node in a wireless communication network or a network side TSN translator, NW-TT, associated with a User Plane Function, UPF, of a core network connected to the network node configured for providing time synchronization between TSN entities of the TSN system, the TSN system being integrated to a wireless communication network, the wireless communication network operating as a virtual TSN node, the virtual TSN node, the DS-TT or the NW-TT being configured for:
receiving, from the TSN system, one or more generalized Precise Timing Protocol, gPTP, frames, each gPTP frame comprising a time stamp indicating time reference information;
evaluating the time reference information in the one or more gPTP frames; and
detecting injection of the false timestamp in a time sensitive communication in accordance with the evaluation.

10. The TSN system according to claim 9, wherein evaluating the time reference information in the one or more gPTP frames comprises:
receiving standard time reference information from an authenticated time source of the wireless communication network; and
estimating a drift between the time reference information in each gPTP frame and the standard time reference information.

11. The TSN according to claim 10, wherein the DS-TT or the NW-TT is configured for detecting injection of the false timestamp in the time sensitive communication in accordance with the evaluation by:
determining whether the estimated drift between the time reference information in each gPTP frame and the standard time reference information is greater than a predefined number of previously estimated drifts; and
when it has been determined that the estimated drift is greater than the predefined number of previously estimated drifts, detecting injection of the false timestamp in the time sensitive communication.

12. The TSN system according to claim 9, wherein the DS-TT or the NW-TT is configured for evaluating the time reference information in the one or more gPTP frames by:
determining a frequency of the one or more gPTP frames being arrived at the DS-TT and the NW-TT.

13. The TSN system according to claim 12, wherein the DS-TT or the NW-TT is configured for detecting injection of the false timestamp in the time sensitive communication in accordance with the evaluation by:
determining whether the frequency of the one or more gPTP frames being arrived at the DS-TT and the NW-TT are same; and
when it has been determined that the frequency of the one or more gPTP frames being arrived at the DS-TT and the NW-TT are not same, detecting injection of the false timestamp in the time sensitive communication.

14. The TSN system according to claim 9, wherein the DS-TT or the NW-TT is configured for evaluating the time reference information in the one or more gPTP frames by:
detecting replication of the one or more gPTP frames comprising the same time reference information.

15. The TSN system according to claim 14, wherein the DS-TT or the NW-TT is configured for detecting injection of the false timestamp in the time sensitive communication in accordance with the evaluation by:
determining whether replication of the one or more gPTP frames comprising the same time reference information is detected; and
when it has been determined that the replication is detected, detecting injection of the false timestamp in the time sensitive communication.

16. The TSN system according to claim 9, wherein the DS-TT or the NW-TT is further configured for transmitting information indicating injection of the false timestamp in the time sensitive communication to at least one entity for enabling the at least one entity for performing one or more of:
reconfiguration of the TSN system; and
reconfiguration of a transmission queue schedule of the NW-TT.

17. A non-transitory computer readable medium, having thereon a computer program comprising program instructions, wherein the computer program is loadable into a data processing unit and configured to cause execution of the method according to claim 1 when the computer program is run by the data processing unit.
